(19) United States
(12) Patent Application Publication
(10) Pub. No.: US 2026/0034532 A1
(43) Pub. Date: Feb. 5, 2026

(54) Gaseous Absorption Compositions And Methods

(71) Applicant: National Technology & Engineering Solutions of Sandia, LLC, Albuquerque, NM (US)

(72) Inventors: Jessica Rimsza, Albuquerque, NM (US); Tina M. Nenoff, Cedar Crest, NM (US); Sakun Duwal, Albuquerque, NM (US); Dayton Jonathan Vogel, Sioux Falls, SD (US); Matthew Scott Christian, Albuquerque, NM (US); Matthew Hurlock, Pasco, WA (US); Harrison Root, Albuquerque, NM (US); Dennis Robinson Brown, Albuquerque, NM (US)

(21) Appl. No.: 19/284,353

(22) Filed: Jul. 29, 2025

Related U.S. Application Data
(60) Provisional application No. 63/677,751, filed on Jul. 31, 2024.

(51) Int. Cl. B01J 20/22; B01D 53/14; B01J 20/28

(52) U.S. Cl. CPC B01J 20/226; B01D 53/14; B01J 20/2808; B01J 20/28083; B01J 20/28085; B01D 2257/504

(57) ABSTRACT

A composition and method for absorption of a selected gas. The compositions amount to porous liquids that include a nanoporous host material suspended in a solvent in the presence of a gas where the nanoporous host material is configured to exclude the absorption of solvent while providing a porosity for gaseous absorption.

### CROSS-REFERENCE TO RELATED APPLICATIONS

This application claims priority to provisional patent application U.S. Ser. No. 63/677,751, entitled “Porous Compositions and Methods for Carbon Capture,” filed Jul. 31, 2024, the disclosure of which is incorporated herein by reference in its entirety.

### GOVERNMENT INTEREST STATEMENT

This invention was made with Government support under Contract No. DE-NA0003525 awarded by the United States Department of Energy/National Nuclear Security Administration. The U.S. Government has certain rights in this invention.

### FIELD OF THE INVENTION

The present invention is directed at gaseous absorption compositions and methods for absorption of a selected gas. The compositions amount to porous liquids that include a nanoporous host material suspended in a solvent in the presence of a gas which nanoporous host material is configured to exclude solvent while providing a porosity for gaseous absorption.

### BACKGROUND OF THE INVENTION

The efficient and low-cost separation and capture of select components of gas streams is a critical challenge within various industries, including energy production. Contaminants can contribute to long-term environmental challenges such as deteriorating air quality, changes in atmospheric composition, and acid rain creating an energy-efficient and cost-effective technologies for gas capture and separation. However, current sorbent technologies are limited in their selectivity, adsorption capacity, and high temperatures required for regeneration that limits their widespread use as a gas capture and separation material.

As a representative example, the most common liquid phase carbon capture adsorbents are aqueous amines (such as monoethanolamine mixtures), which capture carbon through formation of a carbonate or a carbamate. Aqueous amines are not necessarily sufficiently selective for direct air capture as well as being volatile, corrosive, and energy intensive to regenerate via thermal decomposition of the carbonate and/or carbamate phase. Ionic liquids have also been explored for carbon capture but have high humidity sensitivity that complicates their use as a direct air capture material. Finally, porous materials alone, such as metal-organic frameworks, zeolites, porous organic cages, covalent ionic cages have all been explored for carbon capture but are not sufficiently CO₂ selective for direct air capture technologies and also exhibit high humidity sensitivity through similar gas capture mechanisms between CO₂ and H₂O.

What is needed are processes, systems and compositions that overcome one or more of these disadvantages and that provide other advantageous features. Other features and advantages will be made apparent from the present specification. The teachings disclosed extend to those embodiments that fall within the scope of the claims, regardless of whether they accomplish one or more of the aforementioned needs.

### SUMMARY

A composition comprising a nanoporous host material comprising a pore window having a largest diameter indicated by a pore window size (PW_{size}) and a solvent for suspending the nanoporous host material wherein the solvent has a van der Waals diameter (Dvdws). A gas is dispersed in the solvent where said gas has a kinetic diameter (KDg) and wherein PW_{size}>KD_{g} and D_{vdws}>1.8 (PW_{size}).

A composition comprising a nanoporous host material comprising a pore window having a largest diameter indicated by a pore window size (PW_{size}) and a solvent for suspending the nanoporous host material wherein the solvent has a van der Waals diameter (D_{vdws}). A carbon dioxide gas is dispersed in the solvent having a kinetic diameter (KDg) of 3.30 Å and wherein PW_{size}≥3.30 Å and D_{vdws}>5.94 Å.

A method for absorption of a gas wherein one provides a nanoporous host material comprising a pore window having a largest diameter indicated by a pore window size (PW_{size}) and a solvent for the nanoporous host material. The nanoporous host material is suspended in the solvent where the solvent has a van der Waals diameter (Dvdws). One then selects a gas for absorption by the solvent containing the suspended nanoporous host material where the gas has a kinetic diameter (KDg) wherein PW_{size}>KD_{g} and D_{vdws}>1.8 (PW_{size}). This is followed by contacting the solvent containing the suspended nanoporous host material with the selected gas and absorbing the selected gas into the nanoporous host material.

### DRAWINGS

FIG. 1 is a plot of the CO₂/N₂ uptake ratio versus pressure for the indicated solvent (2HAP), zeolite imidazolate frameworks (ZIFs) and porous liquids (ZIF-8+2HAP) and ZIF-L+2-HAP).

### DESCRIPTION OF PREFERRED EMBODIMENTS

The disclosure is directed to porous material compositions that are referred to as porous liquids (PLs) with structural features that result in gaseous adsorption such as the adsorption of CO₂. The disclosed porous liquids preferably capture CO₂ from both pure CO₂ or ambient air (˜400 ppm CO₂). These porous liquids are contemplated as drop-in replacement for current liquid-phase carbon capture materials. Additionally, regeneration mechanisms are disclosed by which the porous liquids can be reused and recycled using the preferred procedure of isostatic compression. Such regeneration mechanism is contemplated to lower the energy costs of carbon capture plants by 70-80%.

Preferably the gaseous absorption herein is such that the gas preferably and selectively enters through a pore window of a porous host material suspended in a selected solvent or liquid where the gas locates within such host material. The subject gas, prior to such absorption can be present at a solvent-porous host material interface or within the bulk solvent.

The porous liquids herein are therefore preferably composed of a nanoporous host material that is suspended in a selected liquid or solvent. Namely, the solvent is selected such that due to the size of the pore window selected for the host material, the gas present within the liquid enters the host material's pore space but the solvent is restricted from doing so. The porous liquids may therefore be understood as a liquid-phase material with permanent porosity. This permanent porosity results in relatively increased gas adsorption capacity and provides gas absorption selectivity due to the capability to now adjust both the nanoporous host's pore window size as well as the size of the liquid or solvent containing the suspended nanoporous host.

Preferably, the level of nanoporous host material suspended in a selected solvent falls in the range of 1.0% (wt.) to 25.0% (wt.) including all values and increments therein. Accordingly, the level of nanoporous material suspended in a selected solvent may fall in the more preferred ranges of 5.0% (wt.) to 25.0% (wt.) or 5.0% (wt.) to 15.0% (wt.), and in one particularly preferred range of 8.0% (wt.) to 15.0% (wt.).

The nanoporous host material may preferably be sourced from metal organic framework (MOF) type molecules, which is reference to metal clusters coordinated to organic ligands. The metals that may be utilized may include Cu, Ni, Co, Fe, Ti, Mn, and Zn. The organic ligands that are employed for the MOF may include mono, di, tri and tetravalent type ligands. Particularly preferred MOF molecules herein for use as the nanoporous host include Zeolitic imidazolate frameworks (ZIFs) that are composed of tetrahedrally-coordinated transition metal ions (e.g., Fe, Co, Zn) connected by imidazolate linkers. Particular preferred ZIFs therefore include zeolite imidazolate framework 8 (ZIF-8) composed of zinc ions and 2-methylimidazole linkers, having the empirical formula C₈H₁₀N₄Zn. Other preferred ZIFs include: (1) ZIF-L which shares a similar composition to ZIF-8 but with a layered structure; ZIF-67 which is composed of cobalt (II) ions linked by 2-methylimidazole molecules having the empirical formula C₈H₁₀N₄Co; (2) ZIF-69 having the empirical formula C₁₀H₆ClN₅O₂Zn; and (3) ZIF-71 having the empirical formula Zn (dcim)₂ where dcim represents the 4,5-dichloroimidazolate linker wherein ZIF-71 may have RHO topology (cages connected by eight membered ring windows) or in the form of a SOD (sodalite) type polymorph.

The nanoporous host material herein may also be sourced from porous organic cage (POC) molecule which is reference to organic building blocks linked together by covalent bonds to form a cage-like structure. Preferred POCs therefore include: (1) ethane diamine cycloimine organic cage, with the empirical formula C₄₈H₄₈N₁₂ identified as CC1; (2) CC3 porous organic cage material with the empirical formula C₉₆H₁₁₆F₁₀O₂S_{1.67}; and (3) CC13 porous organic cage material with the empirical formula C₆₀H₇₂N₁₂.

The nanoporous host material herein may also be sourced from zeolites which is reference to nanoporous aluminosilicate materials, mainly containing aluminum, silicon and oxygen, having the general formula M_{x/n}[(AlO2)ₓ(SiO₂)y].zH₂O where M represents a cation (e.g., Na, K, Ca), n is the cation's valence, and x, y and z are stoichiometric coefficients.

In addition, the nanoporous host material herein may be sourced from ionic covalent organic framework (ICOF) molecules which amount to covalent organic frameworks that have ionic character due to the inclusion of positive ions, negative ions or zwitterions within the framework structure.

The nanoporous host material herein is preferably in the form of a bulk solid material, such as particulate material. Such solid particulate material may be present in various geometric forms, such as round, oval or spherical type particles, cubes, cylinders or other polygonal type shapes. The nanoporous host material herein may also be present as a relatively flat sheet. In such solid bulk form, the nanoporous host material is prepared herein to have a pore window of a selected size, which may be understood as the porosity on a surface of the solid nanoporous host material.

The nanoporous host material herein is also characterized as having a pore window size (PW_{size}). This is reference to the size of the openings on the surface of the nanoporous host material which as noted above, may be in the form of solid particulate material. The pore window size of the nanoporous host material can be conveniently measured via x-ray diffraction or neutron diffraction-based measurements or through gas adsorption studies with different sized gas molecules to identify the size of the pore window. Note that the size of the pore window is chosen to allow for selected gas entry into the nanoporous host material while maintaining solvent exclusion. Therefore, the size of the pore window that is selected will depend upon the size of the solvent and size of the gas, as discussed further herein, for which the nanoporous host is ultimately suspended to provide an overall and relatively effective gaseous absorption composition.

The nanoporous host material also preferably has an internal porosity that provides pores that have a size that falls in the range of less than 100.0 nm, or more preferably in the range of 1.0 nm to less than 100.0 nm, including all values and increments therein. Such size of the internal pores is reference herein to the largest diameter of a given internal pore. Accordingly, the size of the internal pores in the nanoporous host material may more preferably fall in the range of 1.0 nm to 50.0 nm, or 1.0 nm to 25.0 nm, or 1.0 nm to 20.0 nm, or 1.0 nm to 10.0 nm.

As for the preferred size of the nanoporous host material in its bulk solid form, preferably, in the preferred case of particles, they may have the largest diameter of up to 5000 microns (μm), or in the preferred range of 1.0 μm to 5000.0 μm, including all values and increments therein. Other exemplary preferred ranges for the particles include 1.0 μm to 4000.0 μm, 1.0 μm to 3000.0 μm, 1.0 μm to 2000.0 μm or 1.0 μm to 1000.0 μm. If the nanoporous host material is present in some other form, such as cylindrical or in the form of a relatively flat sheet, the thickness of the walls of the cylinder or the sheet may similarly fall within the range of 1.0 μm to 5000.0 μm.

Formation of the porous liquid composition to provide relatively effective gas absorption, depends upon a relationship between the selected size of the pore window (PW_{size}) of the nanoporous host material for which the interior pore space of the host material may be accessed, the size of the gas molecule for absorption as defined by its kinetic diameter (KD_{g}) and the van der Waals diameter of the solvent (D_{vdws}). Accordingly, for relatively effective gas absorption into the nanoporous host material and relatively effective exclusion of solvent from entering the nanoporous host material, it has now been found that the following relationships are preferably selected and maintained: PW_{size}>KD_{g} and D_{vdws}>1.8 (PW_{size}). By observing these relationships, for a given porous liquid composition herein in contact with a selected gas, it is contemplated that 90.0% or more of the gas will now locate within the nanoporous host material with the corresponding exclusion of solvent at a level of less than or equal to 10.0%. Accordingly, it is contemplated that for a given porous liquid composition herein in contact with a selected gas, 90%, 91%, 92%, 93%, 94%, 95%, 96%, 97%, 98%, 99% or 100% of the gas will pass through the porous window and locate within the nanoporous host material and that the corresponding level of solvent located within the nanoporous host material that is designed to be size-excluded by the pore window size may be 10.0%, 9.0%, 8.0%, 7.0%, 6.0%, 5.0%, 4.0%, 3.0%, 2.0%, 1.0% or 0%.

Turning then to the liquid or solvent for the nanoporous host material, as just noted, the van der Waals diameter of the solvent (D_{vdws}) can be conveniently determined by the first calculating the van der Waals volume (V_{vdw}) according to the following equation:

$${V}_{v d W} = \sum all atom contributions - 5.92 {N}_{B} - 14.7 {R}_{A} - 3.8 {R}_{N R}$$

wherein N_{B} is the number of bonds present in the solvent, R_{A} is the number of aromatic rings present in the solvent. Reference to atom contributions is reference to the van der Waals size of the individual atoms of the solvent. See, e.g., J. of Organic Chemistry, Vol. 68, Issue 19, Fast Calculation of van der Waals Volume as a Sum of Atomic and Bond Contributions and its Application to Drug Compounds, Y. Zhao, M. Abraham and A. Zissimos (2003). Then, the van der Waals diameter of the solvent can be conveniently determined from the following expression:

$${D}_{v d w s} = 2 ( {[ 3 {V}_{v d w} / 4 π ]}^{1 / 2} ) .$$

Preferred solvents for use herein are those solvents that have van der Waals diameter that would make them suitable for preparation of the porous fluids for gas absorption herein. Such solvents therefore preferably comprise 2′-hydroxyacetophenone, 2-chlorophenol, p-dioxane, 15-crown-5, glyceryl triacetate, glyceryl tributyrate, acetophenone, methyl benzoate, tetraglyme and dimethyl idsorbide. Other suitable solvents can include 2-flurophenol, 2-bromophenol, 2-isopropylphenol, 2-tertbutyphenol, cyclohexanone, 4-hydroxytoluene, 2,4-dimethylphenol, 2-chloro-6-methylphenol and a solvent mixture of ethylene glycol/water/2-methylimidazole. Table 1 below provides properties of certain preferred solvents herein including values for D_{vdws}. As can be observed, the value of D_{vdws} for the identified preferred solvent falls in the range of 6.0 to 8.0 Å.

TABLE 1
Properties Of Preferred Solvents

| | | Density | |
|---|---|---|---|
| Solvent Name | | [g/mL] | D_{vdws} |
| (Abbreviation) | Structure | at temp. (° C.) | (Å) |
| Glyceryl triacetate (GT) | 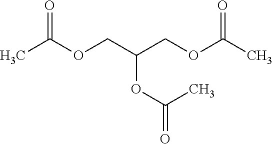 | 1.158 (25) | 7.36 |
| Glyceryl tributyrate (GB) | 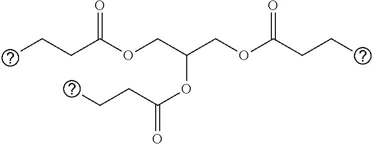 [SMILES: CCCC(=O)OCC(COC(=O)CCC)OC(=O)CCC] | 1.032 (20) | 8.42 |
| 2′- Hydroxyacetophenone (2HAP) | 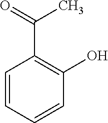 | 1.131 (25) | 6.30 |
| Acetophenone (AP) | 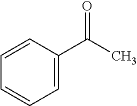 | 1.03 (25) | 6.15 |
| Methylbenzoate (MB) | 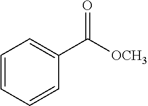 | 1.088 (20) | 6.30 |
| 15-crown-5 (15C5) | 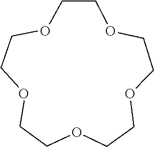 [SMILES: C1COCCOCCOCCOCCO1] | 1.113 (20) | 7.41 |
| Tetraglyme (4G) | 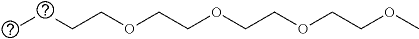 | 1.009 (25) | 7.55 |
| Dimethyl isorbide (DMI) | 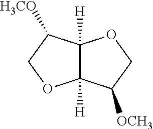 [SMILES: CO[C@H]1CO[C@H]2[C@@H]1OC[C@H]2OC] | 1.15 (25) | 6.70 |

As for the size of the gas, such is reference herein to the kinetic diameter of the gas molecule at issue (KD_{g}). The kinetic diameter is defined as the intermolecular distance of closest approach for two molecules colliding with zero initial energy. Note that the kinetic diameter is the minimum cross-section diameter. The kinetic diameter of the gas can be conveniently evaluated and determined by the Stockmeyer potential function for molecules that do not have a strong dipole-quadrupole interactions and via molecular sieving experiments. Kinetic diameters of various molecules have been reported extensively in literature. See, e.g., Breck, Donald W. Zeolite Molecular Sieves: Structure, Chemistry, and Use (1974). Table 2 below provides kinetic diameters of gases contemplated for absorption and for use within the relationships identified herein. As may be appreciated, such kinetic diameter then sets a preferred value herein for the size of the pore window for the nanoporous host.

TABLE 2
Kinetic Diameters Of Selected Gases

| | Kinetic | | Kinetic | | Kinetic |
|---|---|---|---|---|---|
| | Diameter | | Diameter | | Diameter |
| Molecule | (Å) | Molecule | (Å) | Molecule | (Å) |
| He | 2.60 | N₂ | 3.64 | CO | 3.76 |
| H₂ | 2.89 | Kr | 6.30 | CO₂ | 3.30 |
| Ne | 2.75 | Xe | 3.96 | Cl₂ | 3.20 |
| Ar | 3.40 | NO | 3.17 | H₂O | 2.65 |
| O₂ | 3.46 | N₂O | 3.30 | SF₆ | 5.50 |

As may now be appreciated, in the particular case where one desires to provide a porous liquid composition for absorption of CO₂, the pore window of the nanoporous host must be large enough to allow for CO₂ diffusion into the interior of the nanoporous host material through the pore window (i.e., greater than or equal to 3.3 Å) while also excluding the external solvent in which the porous host material is dissolved/suspended. Accordingly, the van der Waals diameter of the solvent that is selected is one that tracks the relationship noted above, namely D_{vdws}>1.8 (PW_{size}). Accordingly, in the case of CO₂, with a kinetic diameter of 3.3 Å, and using that value to select the value for the pore window size (PW_{size}), the value of D_{vdws} for the selected solvent should then be greater than 5.94 Å (1.8×3.3 Å).

### WORKING EXAMPLES

Materials. Zinc nitrate hexahydrate (98%), 2-methylimidazole (99%; HMIm), 2′-hydroxyacetophenone (99%; 2HAP), dimethyl isosorbide (99%; DMI), glyceryl triacetate (GT), glyceryl tributyrate (99%, GB), tetragrlyme (4G), acetophenone (AP), methylbenzoate (98%, MB), and 15-crown-5 (98%, 15C5) were purchased from Sigma-Aldrich. Methanol was purchased from CMC Materials. He (99.999%) and N₂ (99.999%) gases were purchased from Matheson Trigas. All chemicals were used as received.

Synthesis of ZIF-8. ZIF-8 was synthesized through modification of a previously reported method¹. Two solutions, the first of 2-methylimidazole (26.0 g, 316 mmol) and the second of zinc nitrate hexahydrate (11.6 g, 38 mmol) were each dissolved in 200 ml of methanol. Next, the zinc nitrate-methanol solution was added to the 2-methylimidazole solution under stirring at 850 rpm. The mixture was then stirred for 1 h at ambient temperature (22° C.), resulting in an opaque white solution. The ZIF-8 solid was removed from the solution by centrifugation at 9500 rpm for 15 min. The solid was then washed with methanol and soaked in fresh methanol for 24 h three times. Afterwards the solid was dried in an oven at 60° C. overnight, yielding 3.2 g of ZIF-8. The dried ZIF-8 was then ground using a mortar and pestle followed by activation under dynamic vacuum at 150° C. for 5 h.

Synthesis of ZIF-L. Zinc nitrate hexahydrate (26.6 g, 0.089 mol) was dissolved in 190 mL of water, and 2-methylimidazole (53.2 g, 0.64 mol) was dissolved in 1.81 L of water. Next, the 2-methylimidazole solution was slowly added to the zinc nitrate solution with stirring at 850 rpm. The mixture was stirred for 30 min at room temperature, resulting in an opaque white solution. The ZIF-L solid was removed from the solution by centrifugation at 9500 rpm for 10 min. The solid was then washed with water three times. Finally, the solid was dried in an oven at 60° C. for 6 h, yielding 18.6 g of ZIF-L.

Representative Porous Liquid Formation. In general, to make PLs, representative ZIF material (such as the ZIF-L noted above) was added to the selected solvent, followed by vortex stirring and sonication. For example, a 7.5 wt. % (weight %) ZIF-8 PL in 2HAP was made by adding 0.075 g of ZIF-8 material to 0.925 g of 2HAP in a 4 mL glass scintillation vial. The solution was then vortexed (30 s) followed by sonication (10 min) to provide the PL composition containing the nanoporous host material based on ZIF- in 2′-hydroxyacetophenone.

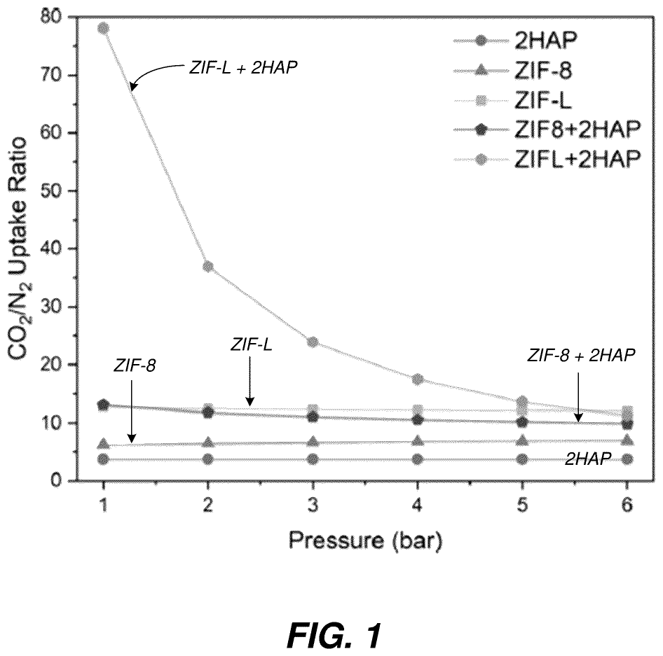

Gas adsorption evaluations of representative ZIF materials are shown in FIG. 1. As can be observed, the CO₂ selectivity of the ZIF-8+2HAP porous liquids almost doubled compared to solid ZIF-8 while the selectivity of the porous liquid of ZIF-L+2HAP increased almost 20 times. The higher selectivity of the porous liquid composition of ZIF-L+2HAP illustrates the favored interactions with the ZIF-L pore window, leading to both the increased CO₂ uptake and decreased N₂ uptake compared to 2HAP. This confirms the relationships disclosed herein for providing relatively efficient gas absorption in the porous liquids, namely that the pore window size of the nanoporous host should be greater than or equal to the kinetic diameter of the gas and that the van der Waals diameter of the solvent should be such that it is greater than 1.8 times to pore window size.

It should be noted that the resulting porous liquids herein have a viscosity that allow for the porous liquid to be piped through a bubbling system with, e.g., a CO₂ containing gas stream or flowed over plates that are exposed to ambient air or preconcentrated gas streams.

The following nanoporous host material and identified solvent combinations may be conveniently prepared herein by following the general preparation methods noted herein: ZIF-8+2-chlorophenol; ZIF-8+2HAP; ZIF-67+2CP; ZIF-71 (SOD)+15C5; ZIF-67+water; ZIF-71 (RHO)+water; ZIF-71 (SOD)+water and ZIF-L+2HAP. It should be noted that the preferred nanoporous host material and solvent for CO₂ or N₂ absorption was identified to be the ZIF-L metal organic framework with 2′-hydroxyacetophenone as the solvent.

While the invention has been described with reference to a preferred embodiment, it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A composition comprising:
a nanoporous host material comprising a pore window having a largest diameter indicated by a pore window size (PW_{size});
a solvent for suspending said nanoporous host material wherein said solvent has a van der Waals diameter (Dvdws); and
a gas dispersed in said solvent where said gas has a kinetic diameter (KDg);
wherein PW_{size}>KD_{g} and D_{vdws}>1.8 (PW_{size}).

2. The composition of claim 1 wherein the nanoporous host material comprises metal organic framework molecules, porous organic cage molecules, zeolites, or ionic covalent organic framework molecules.

3. The composition of claim 1 wherein the nanoporous host material comprises zeolitic imidazolate frameworks composed of tetrahedrally-coordinated transition metal ions connected by imidazolate linkers.

4. The composition of claim 1 wherein said nanoporous host material is suspended in said solvent at a level in the range of 1.0% (wt.) to 25.0% (wt.).

5. The composition of claim 1 wherein said nanoporous host material has an internal porosity comprising pores with a size in the range of 1.0 nm to less than 100.0 nm.

6. The composition of claim 1 wherein said solvent comprises 2′-hydroxyacetophenone, 2-chlorophenol, p-dioxane, 15-crown-5, glyceryl triacetate, glyceryl tributyrate, acetophenone, methyl benzoate, tetraglyme, dimethyl idsorbide, 2-flurophenol, 2-bromophenol, 2-isopropylphenol, 2-tertbutyphenol, cyclohexanone, 4-hydroxytoluene, 2,4-dimethylphenol, 2-chloro-6-methylphenol or a solvent mixture of ethylene glycol/water/2-methylimidazole.

7. The composition of claim 1 wherein the nanoporous host material comprises an imidazolate framework material, the solvent comprises 2′-hydroxyacetophenone and the gas comprises CO₂.

8. The composition of claim 7 wherein said imidazolate framework material comprises ZIF-L having the empirical formula C₈H₁₀N₄Zn as a layered structure.

9. The composition of claim 1 wherein said gas dispersed in said solvent comprises at least one of He, H₂, Ne, Ar, O₂, N₂, K, Xe, NO, N₂O, CO, CO₂, Cl₂, H₂O, or SF₆.

10. A composition comprising:
a nanoporous host material comprising a pore window having a largest diameter indicated by a pore window size (PW_{size});
a solvent for suspending said nanoporous host material wherein said solvent has a van der Waals diameter (Dvdws); and
carbon dioxide gas dispersed in said solvent having a kinetic diameter (KDg) of 3.30 Å;
wherein PW_{size}≥3.30 Å and D_{vdws}>5.94 Å.

11. The composition of claim 10 wherein that nanoporous host material comprises metal organic framework molecules, porous organic cage molecules, zeolites, or ionic covalent organic framework molecules.

12. The composition of claim 10 wherein said nanoporous host material is suspended in said solvent at a level in the range of 1.0% (wt.) to 25.0% (wt.).

13. The composition of claim 10 wherein said nanoporous host material has an internal porosity comprising pores with a size in the range of 1.0 nm to less than 100.0 nm.

14. The composition of claim 9 wherein said solvent comprises 2′-hydroxyacetophenone, 2-chlorophenol, p-dioxane, 15-crown-5, glyceryl triacetate, glyceryl tributyrate, acetophenone, methyl benzoate, tetraglyme, dimethyl idsorbide, 2-flurophenol, 2-bromophenol, 2-isopropylphenol, 2-tertbutyphenol, cyclohexanone, 4-hydroxytoluene, 2,4-dimethylphenol, 2-chloro-6-methylphenol or a solvent mixture of ethylene glycol/water/2-methylimidazole.

15. The composition of claim 10 wherein the nanoporous host material comprises an imidazolate framework material and the solvent comprises 2′-hydroxyacetophenone.

16. A method for absorption of a gas comprising:
providing a nanoporous host material comprising a pore window having a largest diameter indicated by a pore window size (PW_{size});
providing a solvent for said nanoporous host material and suspending the nanoporous host material in said solvent where said solvent has a van der Waals diameter (Dvdws);
selecting a gas for absorption by said solvent containing said suspended nanoporous host material where said gas has a kinetic diameter (KDg) and wherein said PW_{size}≥KD_{g} and D_{vdws}>1.8 (PW_{size}); and
contacting said solvent containing the suspended nanoporous host material with said selected gas and absorbing the selected gas into the nanoporous host material.

17. The method of claim 16 wherein the nanoporous host material comprises metal organic framework molecules, porous organic cage molecules, zeolites, or ionic covalent organic framework molecules.

18. The method of claim 16 wherein said nanoporous host material is suspended in said solvent at a level in the range of 1.0% (wt.) to 25.0% (wt.).

19. The method of claim 16 wherein said nanoporous host material has an internal porosity comprising pores with a size in the range of 1.0 nm to less than 100.0 nm.

20. The method of claim 16 wherein said solvent comprises 2′-hydroxyacetophenone, 2-chlorophenol, p-dioxane, 15-crown-5, glyceryl triacetate, glyceryl tributyrate, acetophenone, methyl benzoate, tetraglyme, dimethyl idsorbide, 2-flurophenol, 2-bromophenol, 2-isopropylphenol, 2-tertbutyphenol, cyclohexanone, 4-hydroxytoluene, 2,4-dimethylphenol, 2-chloro-6-methylphenol or a solvent mixture of ethylene glycol/water/2-methylimidazole.

21. The method of claim 16 wherein said selected gas for absorption comprises at least one of He, H₂, Ne, Ar, O₂, N₂, K, Xe, NO, N₂O, CO, CO₂, Cl₂, H₂O, or SF₆.
